(19) United States
(12) Patent Application Publication
(10) Pub. No.: US 2026/0017109 A1
(43) Pub. Date: Jan. 15, 2026

(54) DATA MIGRATION SYSTEM USING ASYNC TASK REFILL

(71) Applicant: Salesforce, Inc., San Francisco, CA (US)

(72) Inventors: Narsimha Reddy Challa, Hyderabad (IN); Venu Gopal Alapati, Hyderabad (IN)

(73) Assignee: Salesforce, Inc., San Francisco, CA (US)

(21) Appl. No.: 18/885,587

(22) Filed: Sep. 14, 2024

Related U.S. Application Data
(60) Provisional application No. 63/670,556, filed on Jul. 12, 2024.

(51) Int. Cl. G06F 9/50

(52) U.S. Cl. CPC G06F 9/5038; G06F 9/5072; G06F 9/5088; G06F 2209/5011; G06F 2209/5018; G06F 2209/503

(57) ABSTRACT

In some embodiments, a method initiates a set of threads at an engine to perform a set of migration tasks for a migration of data for a plurality of organizations. A refill task is started to monitor a status of migration tasks in the set of migration tasks at a first interval cycle. The refill task is running outside of a context of the engine. At a time in the first interval cycle, the method determines a status of migration tasks in the set of migration tasks. A new migration task is sent to the engine for assignment to a thread that has finished its respective migration task before one of the threads has finished executing a migration task in the set of migrations tasks.

### CROSS-REFERENCE TO RELATED APPLICATIONS

This application this application is entitled to and claims the benefit of the filing date of U.S. Provisional App No. 63/670,556 by Challa et al., titled DATA MIGRATION SYSTEM USING ASYNC TASK REFILL, filed on Jul. 12, 2024 (Attorney Docket No. SFDCP153P), which is hereby incorporated by reference in its entirety and for all purposes.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever

### FIELD OF TECHNOLOGY

This patent document relates generally to databases and more specifically to data migration.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks.

Migrating customer organizations in public cloud environments is an important aspect that requires efficiency. In some examples, data for customer organizations may be migrated from a source to a destination, such as from a private data center to the public cloud or cross-cloud. Generally, the migration tools are resource intensive and may cause extended periods of system downtime, which causes customer business impact if not designed properly.

A mass organization migration (MoM) is an event where a large number of organizations will be migrated to the public cloud during the same maintenance window. The migration event uses an orchestration framework to orchestrate the migrations. Migrating the data for an organization may be a lengthy process that starts well before the actual maintenance window, which may be referred to as the downtime window during which the customer has limited access to the organization. The beginning process is called the lead time to start the data copy for the organization from the source to the destination, which depends on the actual transferable data size of the organization and may continue until the maintenance window begins. Maintenance windows may last for two to three hours where the organization will be kept in a read-only mode to complete certain downtime operations, migrate the data, and then the data of the organizations on the destination can be activated. After the activation, the migration framework may still has to execute a significant number of steps or operations to allow reading and writing of the data for the organizations on the destination.

Some problems may arise for the migration. Sometimes, the final activation of the organizations may exceed the maintenance window due to some long-running operations of one or more organizations, which cause some threads in a thread pool to wait indefinitely. For example, the migration framework may send a batch of operations to a thread pool for execution. The migration engine waits until the batch of operations is finished before sending another batch. When some long-running operations are still executing in only a few threads, the remaining threads may be idle as they have already completed the pending operations.

The maintenance window may be designed to be as short as possible to limit the downtime. Some organizations may not be activated when the maintenance window ends due to the above issues. When the activation of organizations exceeds the maintenance window, the problems may occur with the customers, such as trust issues may occur or problems may result at the customer not being able to access their data that may result in a significant business impact.

### BRIEF DESCRIPTION OF THE DRAWINGS

The included drawings are for illustrative purposes and serve only to provide examples of possible structures and operations for the disclosed inventive systems, apparatus, methods and computer program products for data migration. These drawings in no way limit any changes in form and detail that may be made by one skilled in the art without departing from the spirit and scope of the disclosed implementations.

FIG. 1 depicts a simplified system for migrating data according to some embodiments.

FIG. 2 depicts a simplified flowchart of a method for performing the migration process.

FIG. 3 depicts a simplified flowchart of a method for performing the async task refill process according to some embodiments.

FIG. 4 depicts an example of a process to manage migration tasks without using the async task refill process according to some embodiments.

FIG. 5 depicts an example of executing migration tasks using async task refill process according to some embodiments.

FIG. 6 shows a block diagram of an example of an environment that includes an on-demand database service configured in accordance with some implementations.

FIG. 7A shows a system diagram of an example of architectural components of an on-demand database service environment, configured in accordance with some implementations.

FIG. 7B shows a system diagram further illustrating an example of architectural components of an on-demand database service environment, in accordance with some implementations.

FIG. 8 illustrates one example of a computing device.

### DETAILED DESCRIPTION

### System Overview

During a migration, such as a mass organization migration (MOM) there are a large number of organizations that need to have their data migrated and then be activated during a maintenance window. The organizations may be from customers that are migrating data to the public cloud, such as a multi-tenant cloud environment. For example, different organizations may have their data migrated to destination cells in the cloud. However, other types of migrations may be used. An organization may be any entity, such as a tenant, that has specific data to be migrated.

The migration of the data of an organization involves a certain number of tasks that include steps or operations to be executed. Some of the operations may be synchronous and others may be asynchronous. Synchronous operations have to be executed sequentially and asynchronous operations may be executed in parallel. A long-running synchronous operation may hamper the progress of other migration tasks. If there are any long-running migration tasks, one or more threads may be busy processing the synchronous migration and the rest of the threads may be idle. In general, the migration is orchestrated by an orchestration engine (a cron job) that wake up at a regular intervals and employ a fixed number of threads to execute the migration tasks. The cron jobs operate on a cycle. When the cron job runs, it runs until all the submitted tasks finish. As long as the long-running tasks for certain migrations are getting executed, the remaining threads may be idle as there may not be any active tasks to perform for those threads. Accordingly, one long-running migration will block other migrations that still need to be executed. Thus, the cron cycle may be a time period, such as 1 minute, 1 hour, etc., where at every cycle, a new cron job may be started, but a new cron job cannot be started until all the tasks are completed for the job. To overcome the above problems, an async task refill process is used to assign migration tasks to threads that have finished processing their respective migration tasks. The async task refill process may operate on a shorter cycle than the previous cron job cycle. For example, if the cron job cycle is one minute, ten minutes, one hour, etc., the async task refill process may be shorter. For example, every 30 seconds, the async task refill process may check the status of threads and be able to assign new migration tasks to idle threads even if a long running synchronous task is still being executed by a thread.

Asynchronous task processing delays may also result in delays and may cause extended downtime. Some of the operations may be dependent on other operations. For example, if a step B depends on another step A, step B will be executed only when step A is completed. If step A is an asynchronous operation, then step A may be executed by an external thread, such as a message queue thread, and its completion status will be updated in a database outside of the context of the orchestration engine context. Accordingly, the orchestration engine may not know of the completion of step A until the next cron cycle in which it polls for a new batch of operations. Then, to execute step B, the orchestration engine needs to wait for the status of step A for one or more full cron cycles, and until that time, the operation of step B is blocked. The async task refill process may fetch the status of step A before the end of the cron cycle and provide the status to the orchestration engine such that it can execute step B.

The async task refill process may improve the migration of data. For example, the data migration may be performed more efficiently by using computing resources more efficiently during the maintenance window by limiting idle threads. Also, the migration may be performed faster by efficiently assigning migration tasks to threads.

### System

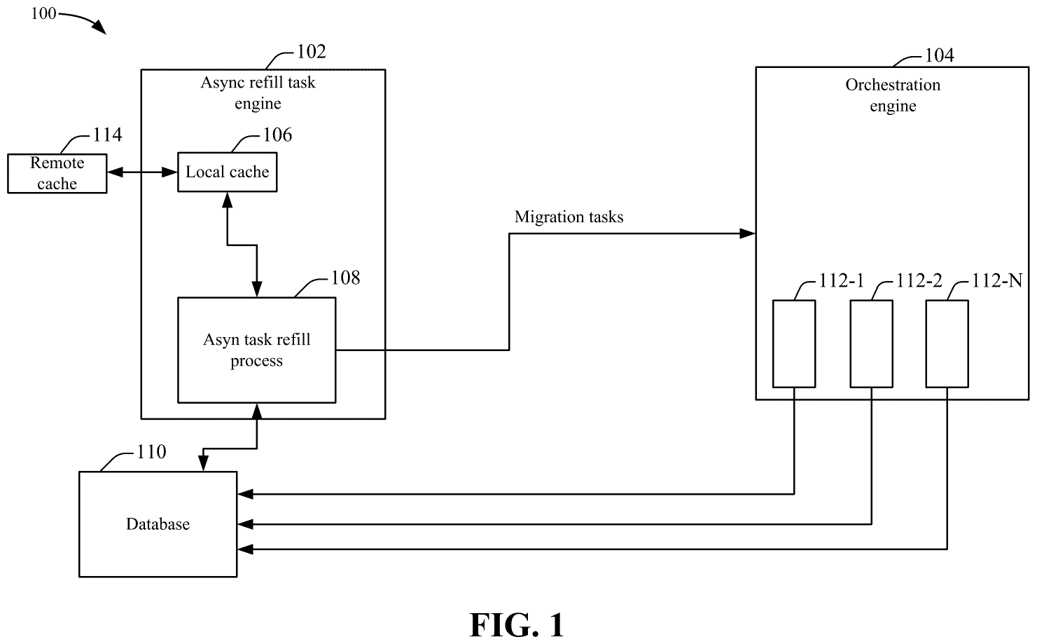

FIG. 1 depicts a simplified system 100 for migrating data according to some embodiments. The data migration may be based on a cron job cycle, which may run automatically at specified intervals to perform a batch of data migration operations. In some embodiments, because async task refill engine 102 continually refills tasks to idle threads, the cron job may run until all tasks for the migration are performed. System 100 may be an application server that includes an async task refill engine 102 and an orchestration engine 104. The functions described may be executed on one or more application servers. For example, multiple application servers may be performing the migrations in parallel.

Async task refill engine 102 and orchestration engine 104 may be executing in a data center to perform the migration of data for multiple organizations. In some embodiments, async task refill engine 102 and orchestration engine 104 operate at the source to migrate data to the destination. The following will describe a mass organization migration, but the process may be used for different migration operations. For example, the process may be used for an inter-data center migration, a migration for one organization or one customer, or other scenarios. The data migration may be from a source to a destination. In some embodiments, the source may be a private data center for an organization and the destination may be a public data center being operated by a company. Also, the migration of data for multiple organizations to the public cloud may be performed. In the migration, the data may be migrated from private data centers of multiple organizations to the public cloud data centers.

Orchestration engine 104 may include a pool of threads 112-1, 112-2, . . . , 112-N (collectively threads 112). The thread pool may be a collection of reusable threads used by orchestration engine 104 to execute migration tasks concurrently. Orchestration engine 104 may control and manage the data migration via threads 112. Threads 112 may be processes that execute operations on computing devices. Threads 112 may be reused to perform operations for multiple migration tasks during the mass organization migration. This improves the overhead, allowing parallel operations to be performed without having orchestration engine 104 creating and destroying threads. In a migration cron, a thread pool is started by orchestration engine 104 and is running continuously. Async task refill process 108 may be started alongside the migration cron, but is independent of a context of the thread pool started by orchestration engine 104. For example, async task refill process 108 operates separately from the thread pool.

In some embodiments, each thread 112 in the thread pool executes a migration task at a time until there are no more executable operations in the migration task. A migration task may be a set of operations that is assigned to a thread. For example, a migration task may migrate data for one organization. In other examples, the migration task may migrate a portion of data for an organization, or data for multiple organizations. A batch of migration tasks may be executed by threads 112 in parallel. Once all pending operations have been completed for a migration task, thread 112 may be available to execute other migration tasks. In some embodiments, a thread 112 may be assigned operations for migrating data for one organization in a migration task. Then, when those operations have been finished, that thread 112 may be assigned a data migration task for another organization that includes other operations. The assignment of migration tasks to threads may go into multiple iterations until all executable operations for all migration tasks are completed.

Async task refill process 108 may maintain the state of ongoing migration tasks at threads 112. At a regular time interval, which may be less than the full migration cron cycle, async task refill process 108 may determine the latest state of migrations, such as from a database 110. Database 110 may store the state of migration tasks whether they are executed by the thread pool or external to the thread pool. Async task refill engine 102 and orchestration engine 104 may not communicate. Database 110 may be used to store the state of migration tasks. Async task refill engine 102 and orchestration engine 104 may separately query database 110 for the state of migration tasks.

Async task refill process 108 may store the updated state in a local cache 106, which is synchronized with a remote cache 114. Local cache 106 may be used to improve the fetching time of state via in-memory transactions instead of requests to database 110. Also, although not shown, there may be multiple application servers that are performing the migrations in parallel, and the remote cache is used to synchronize local caches with the state from other application servers.

The cache refresh helps in fetching the status of any asynchronous tasks from database 110, such as those operations that were completed outside of the thread pool of orchestration engine 104, such as via an external message queue. The use of local cache 106 accelerates the fetching of the status of asynchronous operations while other migrations are still being run by the thread pool. This helps in the immediate execution of any operations that were dependent on the asynchronous operations by detecting the completion status and providing the state to orchestration engine 104 such that any additional migration operation that depended on the completed operations can be executed.

Async task refill process 108 also determines migration operations that have been finished by threads 112, and can then assign new migration operations to those threads 112 to perform. This may limit the time that threads 112 are idle especially when one or more threads are processing a long-running synchronous migration task with multiple operations.

The following will now describe the async task refill process in more detail.

### Migration Process

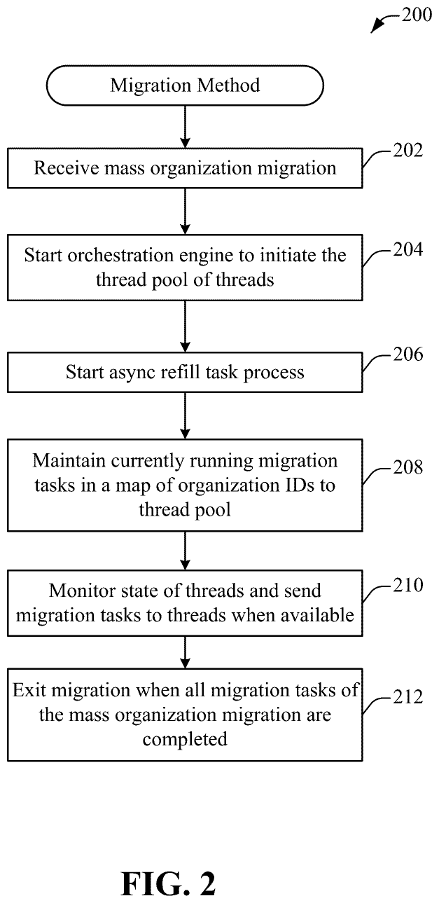

FIG. 2 depicts a simplified flowchart 200 of a method for performing the migration process. At 202, system 100 receives a mass organization migration. The mass organization migration may migrate data for multiple organizations during a defined window. The defined window may have a start time and an end time. For example, the defined window may be two or three hours on a defined day. The defined window means that the data should be migrated and activated during or by the end of the window at the destination. By activation, a read restriction on the data should be removed and read and write access is granted to the data at the destination.

At 204, system 100 starts orchestration engine 104 to initiate the thread pool of threads 112. Also, at 206, system 100 starts async task refill process 108. System 100 may set a cron cycle time and a refill task cycle. The refill task cycle may be shorter in time than the cron cycle, such as the cron cycle is 10 minutes and the refill task cycle is 30 seconds.

At 208, system 100 maintains a status of currently running migration tasks in a map of migration tasks with organization identifiers (IDs) to the thread pool. The currently running migration tasks may be referred to as in-flight migrations. Any completed migration tasks may be removed from the map.

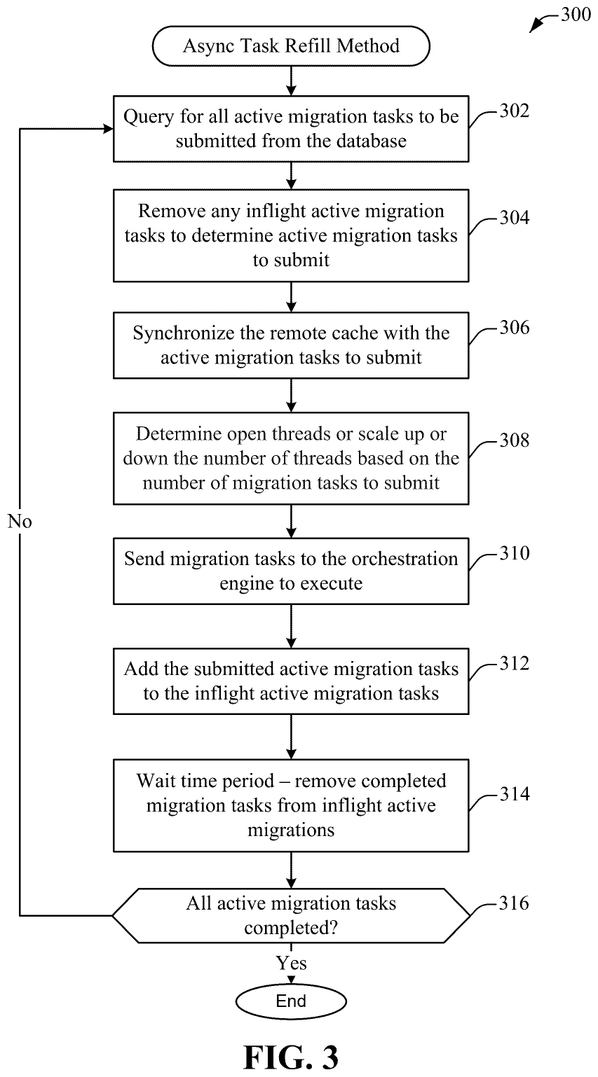

At 212, async task refill process 108 monitors the state of threads 112 and sends migration tasks to threads 112 when available. This process will be described in more detail below starting at FIG. 3. Async task refill process 108 may ensure that threads 112 have limited time in which they are idle. The state of the threads 112 may be monitored on a time period that is less than the cron cycle.

At 212, system 100 exits the migration when all migration tasks of the mass organization migration are completed. Here, orchestration engine 104 may not exit until all the operations of the migrations are completed. Accordingly, the runtime of orchestration engine 104 is extended until no pending operations across all the migrations in the mass organization migration are completed.

The following will now discuss the async task refill process in more detail.

### Async Task Refill

FIG. 3 depicts a simplified flowchart 300 of a method for performing the async task refill process according to some embodiments. At 302, async task refill process 108 queries for all active migration tasks to be submitted from the database 110. Active migrations may be the migration tasks that need to be performed for the mass organization migration. This may be referred to as migrations to submit. The active migrations may be ones that have not been completed by threads 112.

At 304, async task refill process 108 removes any in-flight active migration operations to determine active migration tasks to submit. In-flight active migrations may be the migration tasks that have been submitted to the thread pool and may be currently being processed by threads 112. Here, migrations corresponding to in-flight migrations are removed from migrations to submit.

At 306, async task refill process 108 synchronizes remote cache 114 with the active migration tasks to submit from database 110. Here, async task refill process 108 may refresh local cache 106, which then is synchronized with remote cache 114. This catches up any changes from asynchronous operations such that any new migration operations that are dependent on the asynchronous operations can be processed.

At 308, async task refill process 108 determines open threads 112 or scales up or down the number of threads based on the number of migration tasks to submit. The thread pool may be configured with minimum and a maximum number of threads. As the number of tasks to execute increases, the number of threads in the thread pool may be scaled up to the maximum number of threads allowed and the number of threads may be scaled down when tasks to execute decrease. So, at any point in time, the number of threads in the thread pool will reflect the number of tasks being run.

Async task refill process 108 determines migration tasks to send to orchestration engine 104 for execution based on available threads 112. For example, depending on the number of available threads 112 in the thread pool that can execute migration tasks, async task refill process 108 selects migration tasks. At 310, async task refill process 108 sends migration tasks to orchestration engine 104 to execute. These may be migration tasks to submit to the thread pool. At 312, async task refill process 108 adds the submitted active migration tasks to the in-flight active migration tasks. This then reflects the newly submitted active migration tasks.

At 314, async task refill process 108 waits a time period, such as 30 seconds, and then removes completed migration tasks from in-flight active migrations. For example, async task refill process 108 may query database 110 for the status of completed migration tasks.

At 316, async task refill process 108 determines if all active migration tasks have been completed. If so, the process ends. If not, the process reiterates to 302, where async task refill process queries for all active migration tasks to be submitted. The process then continues as async task refill process 108 continues to refill tasks at threads 112 until all migration tasks have been performed.

Example without Async Task Refill Process

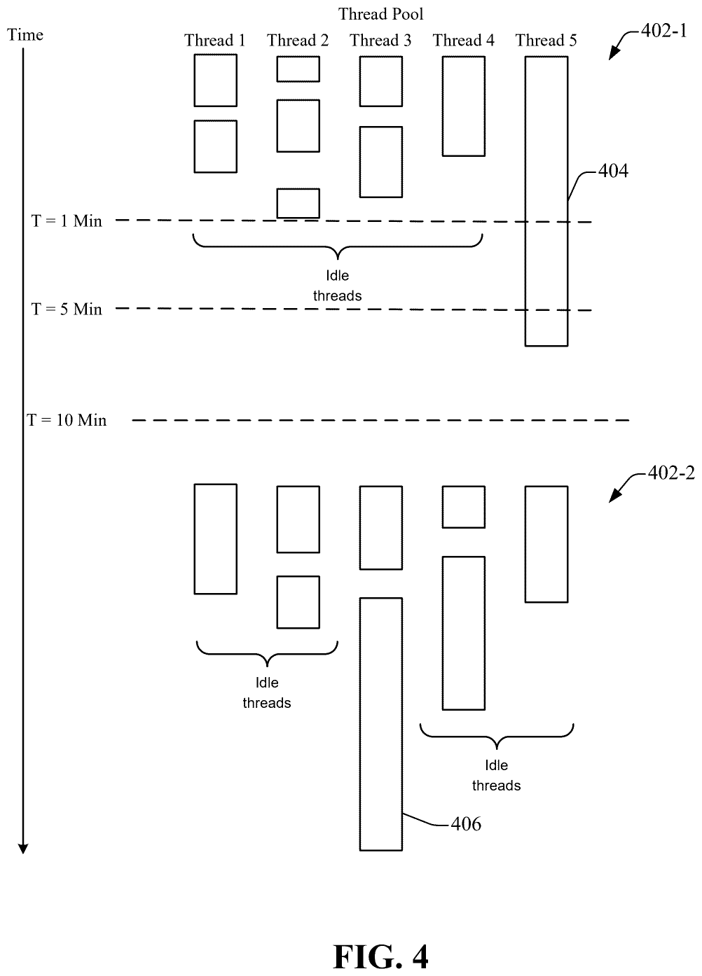

FIG. 4 depicts an example of a process to manage migration tasks without using the async task refill process according to some embodiments. At 402-1, tasks represented by boxes or rectangles are shown as time elapses from top to bottom. The length of the rectangle indicates the time taken to complete the migration task. The cron cycle time may be 5 minutes.

At T=1 minute, threads 1, 2, 3, and 4 have already completed their migration tasks. These threads 112 are now idle. Thread 5 at 506 is still executing, however. From T=1 to T=5 minutes, threads 1, 2, 3, and 4 are idle, but thread 5 at 506 is still executing.

At T=5 minutes, the cron cycle is up and it is detected that thread 5 at 506 is still executing. Accordingly, new migration tasks are not instantiated by orchestration engine 104 at threads 1, 2, 3, and 4. From T=5 to T=10 minutes, threads 1, 2, 3, and 4 are idle.

The task at 404 may be an asynchronous task in which some of the operations are executed asynchronously. At T=5 minutes, it can be determined that one of the tasks has been completed and the next operation can start. However, if any operation was completed before that time, orchestration engine 104 did not know it was completed because the status was updated outside its context in database 110. That is, orchestration engine 104 cannot access the status until polling for the status at its cron cycle time.

At T=10 minutes, another cron cycle occurs and all threads have completed their migration tasks. Then, at 402-2, orchestration engine 104 receives and starts executing a new batch of migration tasks using the threads. However, during this execution, idle threads also result due to a long-running migration task at 404. For example, threads 1, 2, 4, and 5 are idle during the time period.

The async task refill process may improve upon the above.

### Async Task Refill Process Example

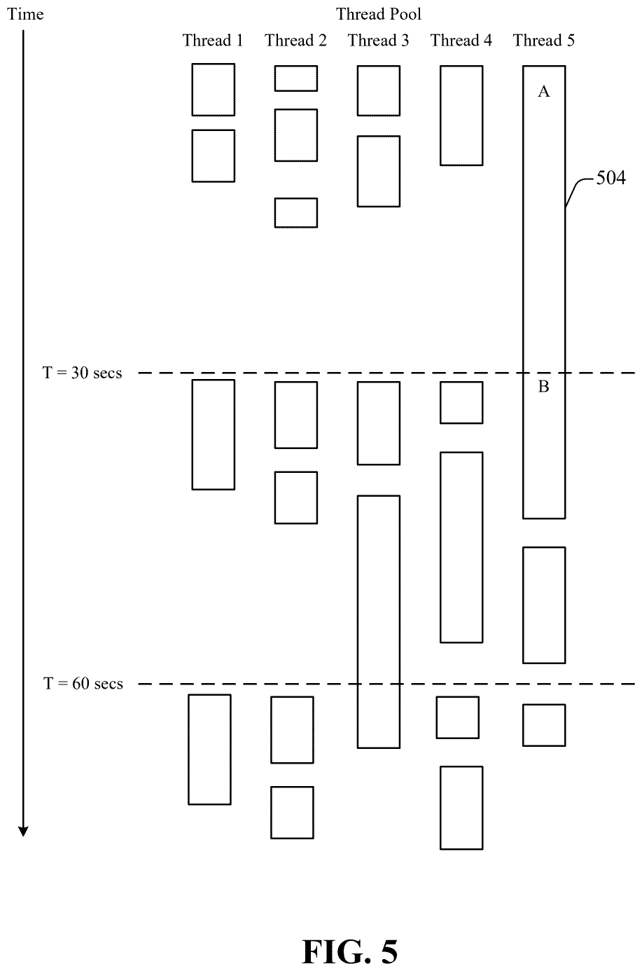

FIG. 5 depicts an example of executing migration tasks using async task refill process 108 according to some embodiments. These migration tasks may or may not be the same as the migration tasks discussed with respect to FIG. 4.

A batch of migration tasks is initiated. Async task refill process 108 may execute in a time period that is shorter than the cron cycle, such as every 30 seconds. Threads 1, 2, 3, 4, and 5 are executing migration tasks shown in rectangles as described above.

A migration task at 504 may include multiple operations. For example, an asynchronous operation A may be executed external to the thread pool, such as by a message queue. This operation may be completed and updated in database 110. Also, threads 1, 2, 3, and 4 may complete their respective migration tasks before T=30 seconds.

At T=30 seconds, async task refill process 108 may determine the status of migration tasks. At T=30 seconds, async task refill process 108 may update the local cache with the status of tasks for threads 1, 2, 3, and 4 as being completed. Also, async task refill process 108 updates local cache 108 with the status that operation A has been completed asynchronously. Also, async task refill process 108 may refresh remote cache 114 with the completion of migration tasks for threads 1, 2, 3, and 4 in addition to the completion of asynchronous task A. Async task refill process 108 determines that asynchronous operation A is completed. In this case, synchronous operation B, which needs to wait until operation A completes can be executed. Here, async task refill process 108 sends a status of operation A such that operation B can be executed before the cron cycle time is reached. Also, async refill process 108 detects that threads 1, 2, 3, and 4 have completed their migration tasks and are idle, and sends new migration tasks for the respective threads.

At T=60 seconds, async task refill process 108 detects that threads 1, 2, 4, and 5 have completed their migration tasks and submits new tasks for those respective threads. At T=60 seconds, asynchronous refill task process 108 updates the local cache with the status for threads 1, 2, 4, and 5 as having completed their migration tasks. Also, asynchronous refill task process 108 refreshes the remote cache with the status of completion for threads 1, 2, 4, and 5. Thread 3 has not finished its task, and continues to execute.

### CONCLUSION

Accordingly, async task refill process 108 may be used to reduce the idle time for threads during migrations, such as migrating data for organizations to the public cloud, or other types of migrations. The migration of customer data at a large scale in a multi-tenant cloud environment using async task refill process 108 reduces system idle time. Also, async task refill process 108 accelerates the migrations with the frequent cache refreshes from database 110 in the case of asynchronous operations in a multi-tenant cloud environment. This efficiently uses system resources by reducing the downtime window for the migrations.

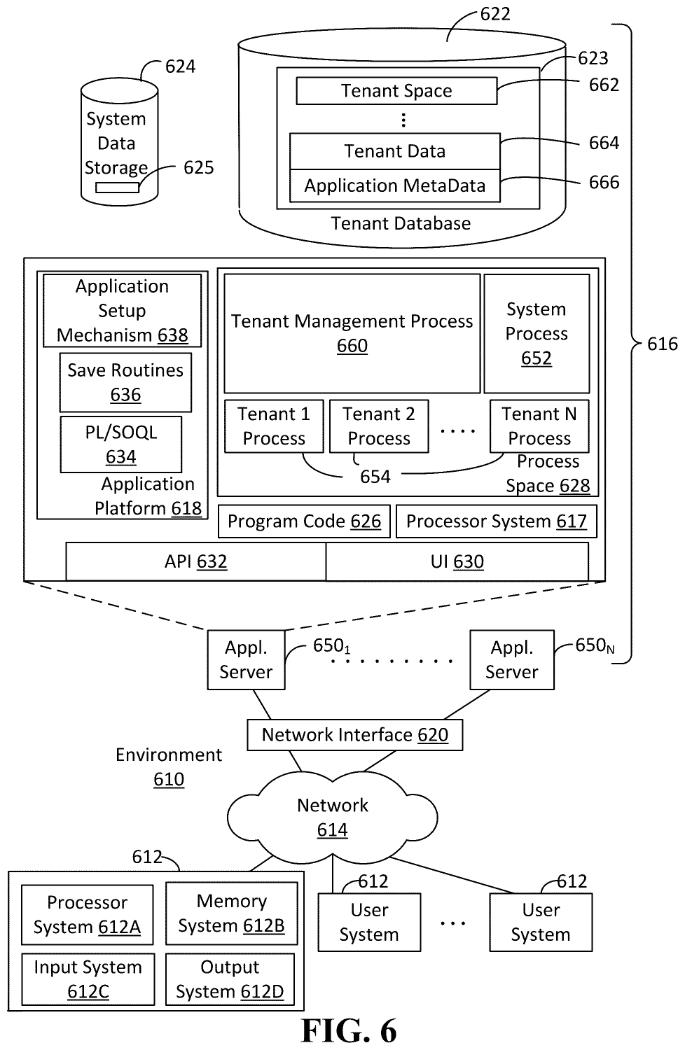

FIG. 6 shows a block diagram of an example of an environment 610 that includes an on-demand database service configured in accordance with some implementations. Environment 610 may include user systems 612, network 614, database system 616, processor system 617, application platform 618, network interface 620, tenant data storage 622, tenant data 623, system data storage 624, system data 625, program code 626, process space 628, User Interface (UI) 630, Application Program Interface (API) 632, PL/SOQL 634, save routines 636, application setup mechanism 638, application servers 650-1 through 650-N, system process space 652, tenant process spaces 654, tenant management process space 660, tenant storage space 662, user storage 664, and application metadata 666. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 616, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 618 may be a framework that allows the creation, management, and execution of applications in system 616. Such applications may be developed by the database service provider or by users or third-party application developers accessing the service. Application platform 618 includes an application setup mechanism 638 that supports application developers' creation and management of applications, which may be saved as metadata into tenant data storage 622 by save routines 636 for execution by subscribers as one or more tenant process spaces 654 managed by tenant management process 660 for example. Invocations to such applications may be coded using PL/SOQL 634 that provides a programming language style interface extension to API 632. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 666 for a subscriber making such an invocation. Such system processes may also manage execution of application metadata 666 as an application in a virtual machine.

In some implementations, each application server 650 may handle requests for any user associated with any organization. A load balancing function (e.g., an F5 Big-IP load balancer) may distribute requests to the application servers 650 based on an algorithm such as least-connections, round robin, observed response time, etc. Each application server 650 may be configured to communicate with tenant data storage 622 and the tenant data 623 therein, and system data storage 624 and the system data 625 therein to serve requests of user systems 612. The tenant data 623 may be divided into individual tenant storage spaces 662, which can be either a physical arrangement and/or a logical arrangement of data. Within each tenant storage space 662, user storage 664 and application metadata 666 may be similarly allocated for each user. For example, a copy of a user's most recently used (MRU) items might be stored to user storage 664. Similarly, a copy of MRU items for an entire tenant organization may be stored to tenant storage space 662. A UI 630 provides a user interface and an API 632 provides an application programming interface to system 616 resident processes to users and/or developers at user systems 612.

System 616 may implement a web-based async task refill engine 102 system. For example, in some implementations, system 616 may include application servers configured to implement and execute async task refill engine 102 software applications. The application servers may be configured to provide related data, code, forms, web pages and other information to and from user systems 612. Additionally, the application servers may be configured to store information to, and retrieve information from a database system. Such information may include related data, objects, and/or Webpage content. With a multi-tenant system, data for multiple tenants may be stored in the same physical database object in tenant data storage 622, however, tenant data may be arranged in the storage medium(s) of tenant data storage 622 so that data of one tenant is kept logically separate from that of other tenants. In such a scheme, one tenant may not access another tenant's data, unless such data is expressly shared.

Several elements in the system shown in FIG. 6 include conventional, well-known elements that are explained only briefly here. For example, user system 612 may include processor system 612A, memory system 612B, input system 612C, and output system 612D. A user system 612 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 612 to access, process and view information, pages and applications available from system 616 over network 614. Network 614 may be any network or combination of networks of devices that communicate with one another, such as any one or any combination of a LAN (local area network), WAN (wide area network), wireless network, or other appropriate configuration.

The users of user systems 612 may differ in their respective capacities, and the capacity of a particular user system 612 to access information may be determined at least in part by “permissions” of the particular user system 612. As discussed herein, permissions generally govern access to computing resources such as data objects, components, and other entities of a computing system, such as an async task refill engine 102, a social networking system, and/or a CRM database system. “Permission sets” generally refer to groups of permissions that may be assigned to users of such a computing environment. For instance, the assignments of users and permission sets may be stored in one or more databases of System 616. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 616 may provide on-demand database service to user systems 612 using an MTS arrangement. By way of example, one tenant organization may be a company that employs a sales force where each salesperson uses system 616 to manage their sales process. Thus, a user in such an organization may maintain contact data, leads data, customer follow-up data, performance data, goals and progress data, etc., all applicable to that user's personal sales process (e.g., in tenant data storage 622). In this arrangement, a user may manage his or her sales efforts and cycles from a variety of devices, since relevant data and applications to interact with (e.g., access, view, modify, report, transmit, calculate, etc.) such data may be maintained and accessed by any user system 612 having network access.

When implemented in an MTS arrangement, system 616 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 616 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 616 may also maintain system-level data usable by multiple tenants or other data. Such system-level data may include industry reports, news, postings, and the like that are sharable between tenant organizations.

In some implementations, user systems 612 may be client systems communicating with application servers 650 to request and update system-level and tenant-level data from system 616. By way of example, user systems 612 may send one or more queries requesting data of a database maintained in tenant data storage 622 and/or system data storage 624. An application server 650 of system 616 may automatically generate one or more SQL statements (e.g., one or more SQL queries) that are designed to access the requested data. System data storage 624 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

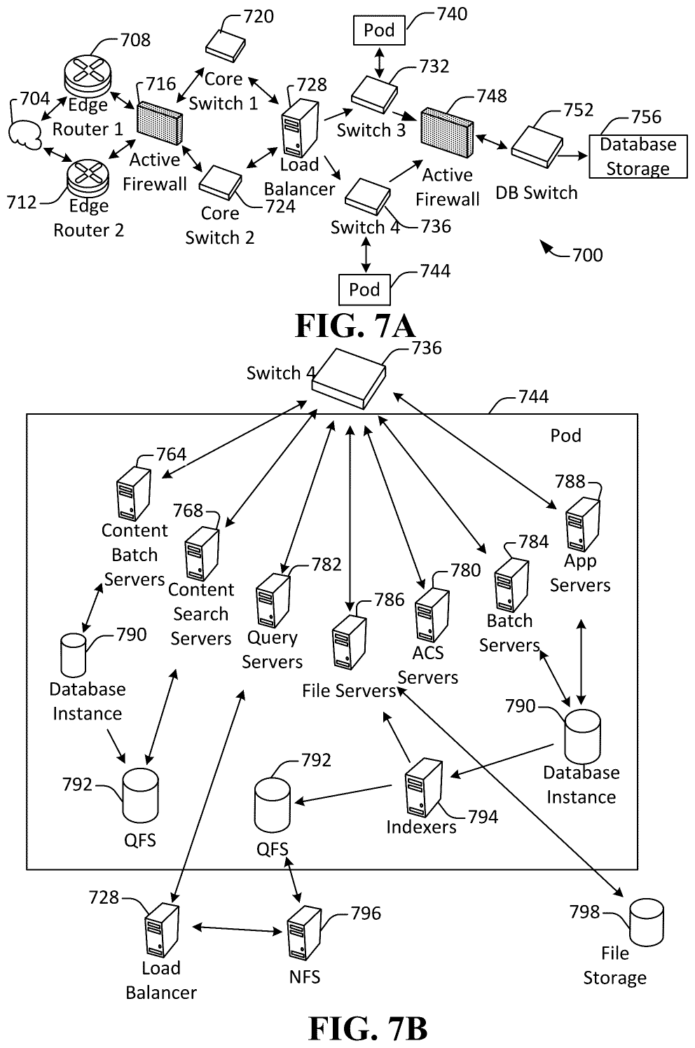

FIG. 7A shows a system diagram of an example of architectural components of an on-demand database service environment 700, configured in accordance with some implementations. A client machine located in the cloud 704 may communicate with the on-demand database service environment via one or more edge routers 708 and 712. A client machine may include any of the examples of user systems 612 described above. The edge routers 708 and 712 may communicate with one or more core switches 720 and 724 via firewall 716. The core switches may communicate with a load balancer 728, which may distribute server load over different pods, such as the pods 740 and 744 by communication via pod switches 732 and 736. The pods 740 and 744, which may each include one or more servers and/or other computing resources, may perform data processing and other operations used to provide on-demand services. Components of the environment may communicate with a database storage 756 via a database firewall 748 and a database switch 752.

Accessing an on-demand database service environment may involve communications transmitted among a variety of different components. The environment 700 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 7A and 7B.

The cloud 704 refers to any suitable data network or combination of data networks, which may include the Internet. Client machines located in the cloud 704 may communicate with the on-demand database service environment 700 to access services provided by the on-demand database service environment 700. By way of example, client machines may access the on-demand database service environment 700 to retrieve, store, edit, and/or process async task refill process information.

In some implementations, the edge routers 708 and 712 route packets between the cloud 704 and other components of the on-demand database service environment 700. The edge routers 708 and 712 may employ the Border Gateway Protocol (BGP). The edge routers 708 and 712 may maintain a table of IP networks or ‘prefixes’, which designate network reachability among autonomous systems on the internet.

In one or more implementations, the firewall 716 may protect the inner components of the environment 700 from internet traffic. The firewall 716 may block, permit, or deny access to the inner components of the on-demand database service environment 700 based upon a set of rules and/or other criteria. The firewall 716 may act as one or more of a packet filter, an application gateway, a stateful filter, a proxy server, or any other type of firewall.

In some implementations, the core switches 720 and 724 may be high-capacity switches that transfer packets within the environment 700. The core switches 720 and 724 may be configured as network bridges that quickly route data between different components within the on-demand database service environment. The use of two or more core switches 720 and 724 may provide redundancy and/or reduced latency.

In some implementations, communication between the pods 740 and 744 may be conducted via the pod switches 732 and 736. The pod switches 732 and 736 may facilitate communication between the pods 740 and 744 and client machines, for example via core switches 720 and 724. Also or alternatively, the pod switches 732 and 736 may facilitate communication between the pods 740 and 744 and the database storage 756. The load balancer 728 may distribute workload between the pods, which may assist in improving the use of resources, increasing throughput, reducing response times, and/or reducing overhead. The load balancer 728 may include multilayer switches to analyze and forward traffic.

In some implementations, access to the database storage 756 may be guarded by a database firewall 748, which may act as a computer application firewall operating at the database application layer of a protocol stack. The database firewall 748 may protect the database storage 756 from application attacks such as structure query language (SQL) injection, database rootkits, and unauthorized information disclosure. The database firewall 748 may include a host using one or more forms of reverse proxy services to proxy traffic before passing it to a gateway router and/or may inspect the contents of database traffic and block certain content or database requests. The database firewall 748 may work on the SQL application level atop the TCP/IP stack, managing applications' connection to the database or SQL management interfaces as well as intercepting and enforcing packets traveling to or from a database network or application interface.

In some implementations, the database storage 756 may be an on-demand database system shared by many different organizations. The on-demand database service may employ a single-tenant approach, a multi-tenant approach, a virtualized approach, or any other type of database approach. Communication with the database storage 756 may be conducted via the database switch 752. The database storage 756 may include various software components for handling database queries. Accordingly, the database switch 752 may direct database queries transmitted by other components of the environment (e.g., the pods 740 and 744) to the correct components within the database storage 756.

FIG. 7B shows a system diagram further illustrating an example of architectural components of an on-demand database service environment, in accordance with some implementations. The pod 744 may be used to render services to user(s) of the on-demand database service environment 700. The pod 744 may include one or more content batch servers 764, content search servers 768, query servers 782, file servers 786, access control system (ACS) servers 780, batch servers 784, and app servers 788. Also, the pod 744 may include database instances 790, quick file systems (QFS) 792, and indexers 794. Some or all communication between the servers in the pod 744 may be transmitted via the switch 736.

In some implementations, the app servers 788 may include a framework dedicated to the execution of procedures (e.g., programs, routines, scripts) for supporting the construction of applications provided by the on-demand database service environment 700 via the pod 744. One or more instances of the app server 788 may be configured to execute all or a portion of the operations of the services described herein.

In some implementations, as discussed above, the pod 744 may include one or more database instances 790. A database instance 790 may be configured as an MTS in which different organizations share access to the same database, using the techniques described above. Database information may be transmitted to the indexer 794, which may provide an index of information available in the database 790 to file servers 786. The QFS 792 or other suitable filesystem may serve as a rapid-access file system for storing and accessing information available within the pod 744. The QFS 792 may support volume management capabilities, allowing many disks to be grouped together into a file system. The QFS 792 may communicate with the database instances 790, content search servers 768 and/or indexers 794 to identify, retrieve, move, and/or update data stored in the network file systems (NFS) 796 and/or other storage systems.

In some implementations, one or more query servers 782 may communicate with the NFS 796 to retrieve and/or update information stored outside of the pod 744. The NFS 796 may allow servers located in the pod 744 to access information over a network in a manner similar to how local storage is accessed. Queries from the query servers 722 may be transmitted to the NFS 796 via the load balancer 728, which may distribute resource requests over various resources available in the on-demand database service environment 700. The NFS 796 may also communicate with the QFS 792 to update the information stored on the NFS 796 and/or to provide information to the QFS 792 for use by servers located within the pod 744.

In some implementations, the content batch servers 764 may handle requests internal to the pod 744. These requests may be long-running and/or not tied to a particular customer, such as requests related to log mining, cleanup work, and maintenance tasks. The content search servers 768 may provide query and indexer functions such as functions allowing users to search through content stored in the on-demand database service environment 700. The file servers 786 may manage requests for information stored in the file storage 798, which may store information such as documents, images, basic large objects (BLOBs), etc. The query servers 782 may be used to retrieve information from one or more file systems. For example, the query system 782 may receive requests for information from the app servers 788 and then transmit information queries to the NFS 796 located outside the pod 744. The ACS servers 780 may control access to data, hardware resources, or software resources called upon to render services provided by the pod 744. The batch servers 784 may process batch jobs, which are used to run tasks at specified times. Thus, the batch servers 784 may transmit instructions to other servers, such as the app servers 788, to trigger the batch jobs.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

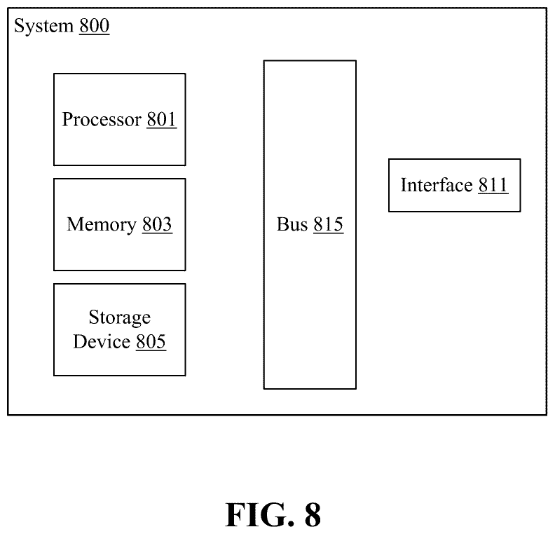

FIG. 8 illustrates one example of a computing device. According to various embodiments, a system 800 suitable for implementing embodiments described herein includes a processor 801, a memory module 803, a storage device 805, an interface 811, and a bus 815 (e.g., a PCI bus or other interconnection fabric.) System 800 may operate as variety of devices such as an application server, a database server, or any other device or service described herein. Although a particular configuration is described, a variety of alternative configurations are possible. The processor 801 may perform operations such as those described herein. Instructions for performing such operations may be embodied in the memory 803, on one or more non-transitory computer readable media, or on some other storage device. Various specially configured devices can also be used in place of or in addition to the processor 801. The interface 811 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method comprising:
initiating a set of threads at an engine to perform a set of migration tasks for a migration of data for a plurality of organizations;
starting a refill task to monitor a status of migration tasks in the set of migration tasks at a first interval cycle, wherein the refill task is running outside of a context of the engine;
at a time in the first interval cycle, determining a status of migration tasks in the set of migration tasks; and
sending a new migration task to the engine for assignment to a thread that has finished its respective migration task before one of the threads has finished executing a migration task in the set of migrations tasks.

2. The method of claim 1, wherein:
the engine polls for updates to the status at a second interval, and
the second interval is longer than the first interval.

3. The method of claim 1, wherein initiating the set of threads comprises:
sending the set of migration tasks in a batch.

4. The method of claim 1, wherein:
the engine does not have access to the status of migration tasks at the time of the first interval cycle.

5. The method of claim 1, wherein determining the status of migration tasks comprises:
maintaining a status of currently running migration tasks at the set of threads;
determining active migration tasks that have not been finished; and
determining migration tasks to be executed based on the currently running migration tasks and the migration tasks that have not been finished.

6. The method of claim 5, further comprising:
adding the new migration task to the currently running migration tasks after sending the new migration task to the engine.

7. The method of claim 1, wherein determining the status of migration tasks comprises:
retrieving a status of a migration task in the set of migration tasks from a database.

8. The method of claim 7, wherein the status of the migration task is updated by a process that performs an operation outside of the set of threads.

9. The method of claim 8, further comprising:
sending a status that the operation has finished to the engine such that another operation that depends on the operation can be executed.

10. The method of claim 7, wherein the status of the migration task is updated when a thread in the set of threads completes the migration task.

11. The method of claim 7, wherein the status of the migration task is not accessible by the engine at the time of the first interval.

12. The method of claim 1, wherein determining the status of migration tasks comprises:
updating a local cache with the status of the migration tasks.

13. The method of claim 12, wherein determining the status of migration tasks comprises:
updating a remote cache with the status of the migration tasks, wherein the remote cache is used to synchronize the status of the migration tasks among multiple computing devices.

14. The method of claim 1, wherein the new migration task is sent when a previous migration task in which the new migration task depends has finished executing.

15. A non-transitory computer-readable storage medium having stored thereon computer executable instructions, which when executed by a computing device, cause the computing device to be operable for:
initiating a set of threads at an engine to perform a set of migration tasks for a migration of data for a plurality of organizations;
starting a refill task to monitor a status of migration tasks in the set of migration tasks at a first interval cycle, wherein the refill task is running outside of a context of the engine;
at a time in the first interval cycle, determining a status of migration tasks in the set of migration tasks; and
sending a new migration task to the engine for assignment to a thread that has finished its respective migration task before one of the threads has finished executing a migration task in the set of migrations tasks.

16. The non-transitory computer-readable storage medium of claim 15, wherein:
the engine polls for updates to the status at a second interval, and
the second interval is longer than the first interval.

17. The non-transitory computer-readable storage medium of claim 15, wherein determining the status of migration tasks comprises:
maintaining a status of currently running migration tasks at the set of threads;
determining active migration tasks that have not been finished; and
determining migration tasks to be executed based on the currently running migration tasks and the migration tasks that have not been finished.

18. The non-transitory computer-readable storage medium of claim 15, wherein determining the status of migration tasks comprises:
retrieving a status of a migration task in the set of migration tasks from a database.

19. The non-transitory computer-readable storage medium of claim 18, wherein the status of the migration task is updated by a process that performs an operation outside of the set of threads.

20. An apparatus comprising:
one or more computer processors; and
a computer-readable storage medium comprising instructions for controlling the one or more computer processors to be operable for:
initiating a set of threads at an engine to perform a set of migration tasks for a migration of data for a plurality of organizations;
starting a refill task to monitor a status of migration tasks in the set of migration tasks at a first interval cycle, wherein the refill task is running outside of a context of the engine;
at a time in the first interval cycle, determining a status of migration tasks in the set of migration tasks; and
sending a new migration task to the engine for assignment to a thread that has finished its respective migration task before one of the threads has finished executing a migration task in the set of migrations tasks.
